(19) United States
(12) Patent Application Publication
(10) Pub. No.: US 2026/0350299 A1
(43) Pub. Date: Nov. 5, 2026

(54) FORMAT REUSE ENGINE(S) FOR PRESERVING FORMATTING DURING CONTENT GENERATION

(71) Applicant: Microsoft Technology Licensing, LLC, Redmond, WA (US)

(72) Inventors: Alyssa Rachel MAYO, Redmond, WA (US); Bhavuk JAIN, Lynnwood, WA (US); Brandon PADDOCK, Seattle, WA (US); FNU KARTIK, Kirkland, WA (US); Guiyu YE, Redmond, WA (US); Javier JIMENEZ JUAREZ, Kirkland, WA (US); Keri Sage GILBERT, Bellevue, WA (US); Kirk Andrew LENNSTROM, Issaquah, WA (US); Mahaveer KOTHARI, Redmond, WA (US); Renato Oliveira DOS SANTOS, Olinda (BR); Sang Jun LEE, Redmond, WA (US); Archana Rao NAIR, Sammamish, WA (US); Sunwoo CHOI, San Francisco, CA (US); Xinyu HE, Vancouver (CA); Xun WANG, Amherst, MA (US); Yu Been LEE, Queens, NY (US)

(21) Appl. No.: 19/194,657

(22) Filed: Apr. 30, 2025

(51) Int. Cl. G06F 40/186; G06F 16/901; G06F 16/906; G06F 16/93; G06F 40/103

(52) U.S. Cl. CPC G06F 40/186; G06F 16/901; G06F 16/906; G06F 16/93; G06F 40/103

(57) ABSTRACT

Systems and methods herein provide a format reuse engine and its related functions for preserving formatting during content generation. The format reuse engine may receive a request to update content within an input document containing content elements and formatting elements defining the format, style, and structure of the content elements. The format reuse engine may assign identifiers to the content elements and identify one or more grounding documents for updating the content within the input document. Based on the grounding documents and the content elements, the format reuse engine may generate updated content elements, such as via a content generator. The format reuse engine may map the updated content elements to the content elements using the identifiers and generate an updated document by replacing the content elements with the updated content elements based on the mapping. As such, the updated content elements inherit the formatting elements of the input document.

### TECHNICAL FIELD

Aspects of the disclosure are related to the field of computer software applications and services and, in particular, to format reuse engine(s) for preserving formatting during content generation.

### BACKGROUND

In an increasingly digital world, business and personal pursuits are increasingly reliant on digital content as primary means of communication and recordkeeping. Digital content, such as documents, digital messages, and presentations, conveys meaning not only through the textual and visual elements themselves, but also through the formatting applied to the content elements. That is, formatting—encompassing layout, typography, spacing, alignment, and structural organization—plays an important role in how information is interpreted, navigated, and retained by a reader. Effective formatting enhances readability, emphasizes key points, and reflects professionalism, thereby influencing the clarity, tone, and overall impact of the end product. Moreover, within some enterprise contexts, formatting also ensures compliance with institutional or industry standards, reinforcing credibility and functionality.

### SUMMARY

Technology disclosed herein includes software applications and services that provide a format reuse engine, and its related functions. In an aspect, a format reuse engine is leveraged to preserve formatting of an input document during content generation. For example, the format reuse engine may receive a request to update content within an input document. The input document may include content elements and formatting elements defining the format, style, and structure of the content elements. The format reuse engine may identify at least a subset of the content elements for the update and assign a unique identifier to the subset of the content elements. In some cases, the format reuse engine may generate a structured representation of the content elements as provided in the input document and assign the identifiers to the content elements within the structured representation.

The request to update content within the input document may identify one or more grounding documents for the update. The grounding documents may serve as source material from which the update is generated. To generate updated content, the format reuse engine may submit a prompt first to a content generator, such as a Large Language Model (LLM), requesting that updated content elements be generated based on the structured representation and the one or more grounding documents. Responsive to receiving the first prompt, the content generator may output the updated content elements.

In some embodiments, the updated content elements may be unstructured or have a structure that is different than the content elements of the input document. As such, the format reuse engine may map the updated content elements to the original content elements. To map the updated content elements to the original content elements, the format reuse engine may generate and submit a second prompt to the content generator requesting that the updated content elements be indexed according to the identifiers of the content elements within the structured representation. Responsive to receiving the second prompt, the content generator may index the updated content elements to the identifiers of the content elements and provide the indexed updated content elements to the format reuse engine. Using the indexed updated content elements, the format reuse engine may map the updated content elements to the original content elements using the identifiers. Using the mapping, the format reuse engine may replace the original content elements with updated content elements to generate an updated document. Because only the content elements are replaced, the formatting elements of the original input document are preserved. As a result, the updated content elements inherit the formatting elements (e.g., the format, style, and structure) of the original content elements.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a format reuse engine, according to an embodiment herein;

FIG. 2 illustrates an example environment in which a format reuse engine is leveraged to preserve the formatting of an input document during content generation, according to an embodiment herein;

FIG. 3 illustrates a process for providing a format reuse engine and its related functions, according to an embodiment herein;

FIG. 4 illustrates an example input document containing content elements and various formatting elements, according to an embodiment herein;

FIG. 5 illustrates an example updated document based on the input document of FIG. 4, according to an embodiment herein;

FIG. 6 illustrates an example graphical user-interface (GUI) provided to a user of a client device initiating a functionality of a format reuse engine, according to an embodiment herein;

FIG. 7 illustrates an example GUI showing a subsequent view of the GUI of FIG. 6 responsive to a request to update input content, according to an embodiment herein;

FIG. 8 illustrates an example GUI showing updated content based on the input content of FIG. 7, according to an embodiment herein;

FIGS. 9A-D illustrate an example flow for generating a template document from an input document or input content, according to an embodiment herein;

FIG. 10 illustrates an example flow for providing one or more functions of a format reuse engine, according to an embodiment herein; and

FIG. 11 shows an example client device suitable for providing a format reuse engine and related functions, according to an embodiment herein.

### DETAILED DESCRIPTION

In today's digital landscape, both professional and personal activities increasingly rely on digital content as a primary medium for communication and recordkeeping. Digital content—such as documents, digital messages, and presentations—conveys information not only through its content elements, but also through the formatting elements applied to those content elements. Formatting elements, including layout, typography, spacing, alignment, and structural organization, influence how digital content is interpreted, navigated, and retained by a viewer. Consistent application of formatting elements can improve readability, guide attention to specific content elements, and reflect a professional tone. In some enterprise contexts, formatting elements also support adherence to institutional or industry conventions, contributing to the credibility and usability of the digital content.

Formatting elements are often applied based on the type and role of the content elements, which include the substantive components of digital content such as text, images, tables, and other embedded media. For instance, content elements (e.g., the text) in a header may have different formatting elements—such as font size, weight, or spacing—than content elements in the body following the header. Similarly, text placed within a table may use distinct alignment or padding compared to standard paragraph text, in order to present information in a structured and accessible manner. Other types of content elements, such as images or lists, may also require specific formatting elements to ensure proper positioning, scaling, and visual coherence within the overall structure of the digital content.

When content elements within digital content are modified—such as through editing text, updating data, or adding new sections—the associated formatting elements often require adjustment to maintain consistency and visual structure. For example, inserting a new section may involve updating heading levels, list styles, or page breaks. Replacing text in a table cell may alter the alignment or disrupt the intended spacing, prompting a need for reformatting. In structured documents, formatting elements are frequently context-dependent, and changes to one content element can affect the formatting of neighboring or related elements. As a result, content updates are commonly followed by reformatting to preserve the intended appearance, organization, and readability of the digital content.

Reformatting in response to updated content becomes even more pervasive when updated content elements are generated by a content generator, such as a deep learning model. For instance, a deep learning model—such as a large language model (LLM)—is trained on large datasets to generate human-like text based on input prompts, and may produce updated content that varies in length, structure, or style from the original content elements. This variability can disrupt existing formatting elements or introduce inconsistencies in the structure and volume of content elements within the digital content. For example, a generated paragraph may not conform to expected line lengths, indentation, or heading structure, requiring additional formatting adjustments to align with the surrounding document. In tabular or structured formats, generated content may omit necessary delimiters, misalign with predefined column widths, or fail to observe expected spacing, further increasing the need for post-generation formatting. Because content generators typically focus on producing semantically relevant output rather than visually formatted content, updated content elements generated by content generators often require reformatting for accurate and cohesive integration into the original document.

The need to reformat digital content in response to updated content elements presents several practical limitations. First, the reformatting process can be time-consuming and labor-intensive, particularly for complex or lengthy documents with multiple interdependent formatting elements. Manual reformatting increases the risk of inconsistency or human error, which can affect the readability and perceived quality of the digital content. Additionally, frequent reformatting may disrupt workflow efficiency, especially when updates are iterative or generated dynamically, such as through automated content generation tools. In collaborative environments, inconsistent application of formatting elements across contributors can further complicate document maintenance. Moreover, reliance on manual or ad hoc formatting methods can hinder scalability and reduce the reliability of automated document pipelines, making it difficult to ensure uniform presentation across large volumes of content or across different document types.

To address at least the above shortcomings associated with updating and reformatting digital content, a format reuse engine is provided herein. In particular, a format reuse engine is provided herein for updating a document with updated content elements while preserving the formatting of the original document. As will be described in greater detail below, responsive to receiving a request to update a document or content elements within the document, the format reuse engine may parse the document to determine the content elements and respective formatting elements that define the format, style, and structure of the content elements within the document. In some cases, the format reuse engine may also determine which content elements are substantive content elements for revision and which content elements should be preserved.

As part of the request to update the document, the one or more grounding documents may be identified. That is, the grounding documents may contain the source material from which updated content is generated. As will be described in greater detail below to update the document, the format reuse engine may provide the one or more grounding documents, along with the content elements identified for revision to a content generator. Responsive to receiving the grounding documents and the content elements, the content generator may generate updated content elements. The updated content elements may contain the requested content as retrieved from the grounding documents, expressed in a syntax, phrasing, and linguistic style that match the content elements of the original document.

As noted above, a challenge in integrating updated content generated by a content generator into an existing document lies in differences in structure, volume, and layout between the updated content elements and the original content elements being revised. To address the discrepancies between the content elements and the updated content elements generated by the content generator, the format reuse engine maps the updated content elements to the original content elements. In some cases, the format reuse engine may coordinate with the content generator to map the updated content elements to the original content elements. Then, once the updated content elements are mapped, the format reuse engine revises the document by replacing the original content elements with the updated content elements. In particular, the format reuse engine replaces the original content elements with the updated content elements while preserving the formatting elements of the original document, thereby requiring minimal-to-no rework of the formatting in the updated document.

By preserving the formatting of a document while updating only its content elements—such as text or images—based on one or more grounding documents the format reuse engine offers numerous technical and practical advantages. Technically, by separating the content elements from the formatting elements of the document, the format reuse engine streamlines automated content integration by eliminating the need for complex layout inference or re-rendering, thereby reducing processing overhead and minimizing the risk of formatting errors. The format reuse engine also enables modular updates, allowing content elements to be refreshed or localized without disrupting the underlying document structure or design templates. Practically, the format reuse engine preserves formatting, thereby ensuring visual and structural consistency across revisions, which may be important for brand integrity, regulatory compliance, and user readability. The format reuse engine also accelerates editorial workflows by reducing manual formatting tasks and facilitating compatibility with downstream systems that rely on fixed formatting standards, such as publishing platforms or content management systems.

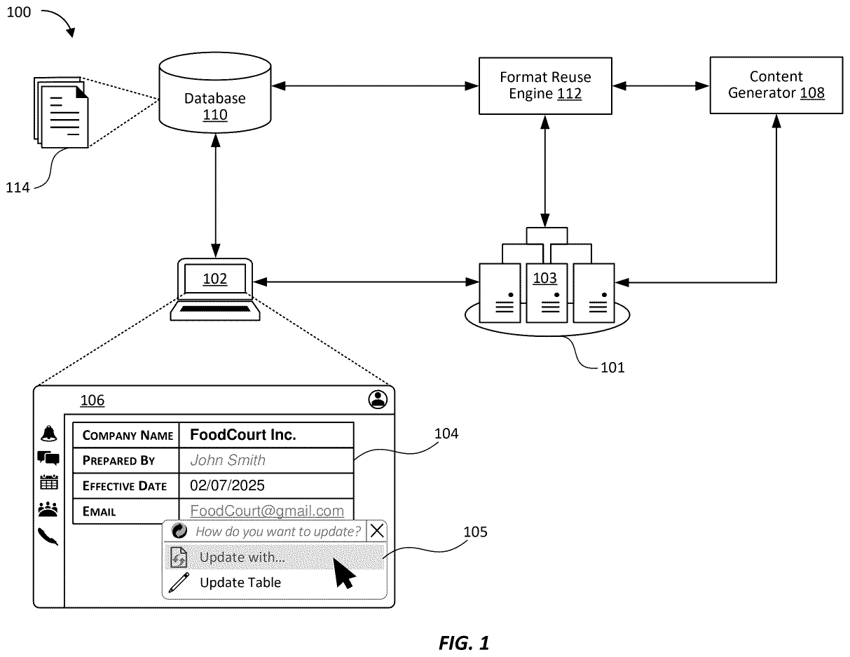

Turning now to the Figures, FIG. 1 illustrates an operational environment 100 for providing a format reuse engine 112, according to an embodiment herein. As illustrated, the operational environment 100 includes a client device 102 in operable communication with an application service/platform 101. The environment 100 facilitates various user-facing operations, such as accessing productivity applications, managing data workflows, and executing collaborative tasks. As such, the client device 102 may interact with the application service/platform 101 to utilize hosted software services—such as word processing, spreadsheet editing, or slide presentations—through a web-based or native interface.

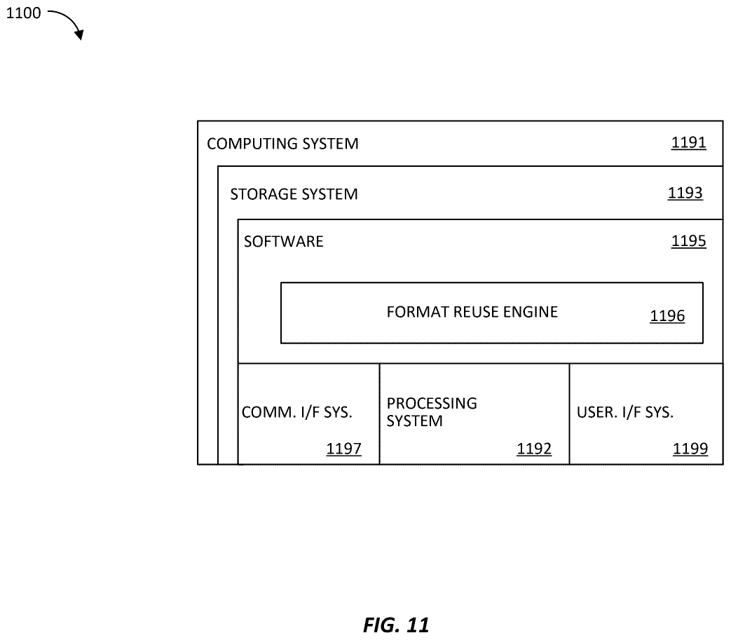

The application service/platform 101 is hosted on the computer servers 103, which provide the necessary computational infrastructure to support the execution of application logic and the management of client sessions. The computer servers 103 may include physical servers, virtual machines, or cloud-based containerized services that deliver the underlying resources such as processing power, memory, persistent storage, and networking capabilities. The system 1100, illustrated in FIG. 11, is broadly representative of the computer servers 103. Among their responsibilities, the computer servers 103 perform core processing tasks, maintain data consistency and security, and manage communication between various components connected within the environment 100. The servers 103 may further implement load balancing, redundancy, and failover mechanisms to ensure high availability and fault tolerance.

The application service/platform 101 may be an application service in some embodiments, while in other embodiments the application service/platform 101 may be an application platform. The term “application service/platform” is used herein to reflect this dual representation. In embodiments where the application service/platform 101 operates as an application service, the application service/platform 101 delivers one or more remotely hosted software applications to the client device 102 on demand, enabling users to access productivity tools and functionality over a network connection. In other embodiments, the application service/platform 101 may function as an application platform, providing the underlying infrastructure and interfaces—such as application programming interfaces (APIs), execution environments, authentication modules, and data services—necessary to develop, extend, and orchestrate multiple applications within the environment 100.

The application service/platform 101 is in operable communication with the client device 102. The client device 102 may be a desktop computer, laptop, tablet, smartphone, or another network-enabled computing terminal capable of executing user interfaces and rendering interactive application content. Through a communication link—facilitated via a local area network (LAN), a virtual private network (VPN), or the public internet—the client device 102 may access hosted applications, retrieve and store user data, receive content updates, and perform various operational tasks. Data exchange between the client device 102 and the application service/platform 101 may occur over protocols such as HTTP/HTTPS, WebSockets, or message queuing systems, enabling real-time, bidirectional communication.

For example, a user operating the client device 102 may launch a productivity application (e.g., a word processor) that is hosted by the application service/platform 101. As illustrated, the client device 102 displays content 104 via a user interface 106. When the user interacts with the content 104, input events—such as keystrokes, text selections, formatting commands, or document save requests—are transmitted from the client device 102 to the application service/platform 101. The computer servers 103 receive and process these inputs to update the document state, apply formatting rules, or invoke supporting services such as spellchecking, autosave routines, or AI-assisted content generation. Processed results are then returned to the client device 102, which updates the user interface 106 accordingly.

In some embodiments, the user may leverage a content generator 108 to generate or update the content 104. The content generator 108, which may be in operable communication with the application service/platform 101, may be an artificial intelligence (AI)-based model, such as a deep learning model that generates natural language text, images, tables, or other media content based on user input, contextual data, or predefined prompts. The content generator 108 may be configured to receive input from the client device 102, such as prompts, context elements, or other user-provided data, and generate new or supplementary content in response. In various implementations, the content generator 108 may operate autonomously or semi-autonomously, with the level of user input or oversight varying based on the specific use case or configuration.

As noted above, a common challenge that arises during document revision or updating is the management of formatting. As the user interacts with the content 104, these interactions frequently necessitate updates to the associated formatting elements. The content 104 may include various content elements, such as text, images, tables, or other media, as well as formatting elements that define the structural layout, visual style, and presentation attributes of the content elements. Formatting elements may include, for example, paragraph styles, font types, font sizes, alignment, indentation, spacing, color schemes, headers, footers, numbering schemes, and other document style settings. As such, when the user modifies the content elements, these input events often affect any associated formatting elements. Thus, as a user interacts with the content 104, updating the formatting of the content 104 is an iterative process where a modification to the content elements requires adjustment of the associated formatting elements.

As the volume or frequency of modifications to the content 104 increases, the complexity and scope of the associated formatting requirements also increase. For example, if the user utilizes an AI-driven content generation system—such as the content generator 108—to supplement or replace portions of the content 104, the generated output may include formatting elements that differ, at times significantly, from those already applied within the content 104. These inconsistencies may include mismatches in font styles, indentation, line spacing, heading hierarchies, or other stylistic attributes. The formatting mismatch is even more evident when the content 104 includes structured elements such as tables, lists, or figures, where the formatting elements are constrained or defined by the underlying content elements. Consequently, integrating such generated content often necessitates substantial formatting revisions to ensure visual and structural consistency across the entire document.

The need for continual reformatting as content 104 is modified or expanded—whether manually or via AI-based systems like content generator 108—presents both technical and practical challenges. From a technical standpoint, each modification may trigger a cascade of formatting dependencies that must be re-evaluated and updated to maintain consistency, which can lead to increased processing overhead and system latency, particularly in real-time or collaborative editing environments. Moreover, repeated formatting adjustments increase the risk of introducing inconsistencies or errors, especially in complex documents where formatting rules are interdependent or nested (e.g., multi-level lists within tables). Practically, this imposes a burden on the user, who must devote time and attention to correcting or reapplying formatting with each content update, detracting from higher-value tasks such as content creation or review. Without an efficient mechanism to reconcile formatting changes dynamically and contextually, the cumulative impact of ongoing revisions can degrade both user experience and document quality.

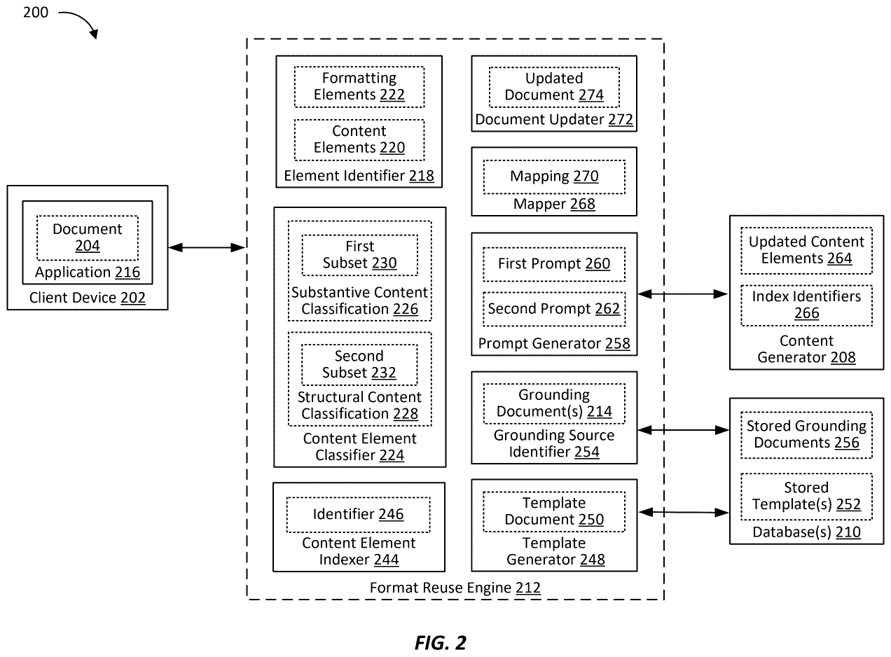

To address at least the above shortcomings of conventional approaches to document/content revision, the environment 100 leverages a format reuse engine 112. As will be described in greater detail below with respect to FIGS. 2-10, the format reuse engine 112 may be in operable communication with the client device 102, such as via the application service/platform 10, to preserve formatting elements during revision of the content 104. In particular, the format reuse engine 112 may be leveraged to maintain formatting of the content 104 when the user updates the content 104 using the content generator 108.

In an example embodiment, the client device 102 submits a request 105 to update the content 104 based on one or more grounding documents 114. The grounding documents 114 may be stored in a database 110. As illustrated, the client device 102 is in operable communication with the database 110, which stores data, documents, and other related content. The database 110 may be locally associated with the client device 102, remotely associated with the application service/platform 101, or accessible by both. In some implementations, the database 110 functions as a central repository for content 104, grounding documents 114, user inputs, and generated outputs, enabling synchronized access and real-time updates across devices and services.

The format reuse engine 112 may be locally operated and executed on the client device 102, while in other embodiments, the format reuse engine 112 may be remotely operated and executed, such as via the application service/platform 101. While in yet other embodiments, one or more functions of the format reuse engine 112 may be locally executed while the remaining functions are remotely executed. As such, depending on the embodiment, the format reuse engine 112 may receive the request 105 directly from the client device 102 or may receive the request 105 via the application service/platform 101.

Regardless of the pathway, responsive to receiving the request 105, the format reuse engine 112 may coordinate with the content generator 108 to generate updated content based on the one or more grounding documents 114 and the input content 104. In particular, the format reuse engine 112 may coordinate with the content generator 108 to not only generate the requested updated content based on the grounding documents 114, but the format reuse engine 112 may also coordinate to ensure that the formatting elements of the input content 104 are preserved and accurately applied to the updated content. In other words, the format reuse engine 112 ensures that minimal-to-no modification to the formatting elements are required when the updated content is integrated into the original content 104. This functionality, along with specific examples, is provided in greater detail in the following Figures and related description.

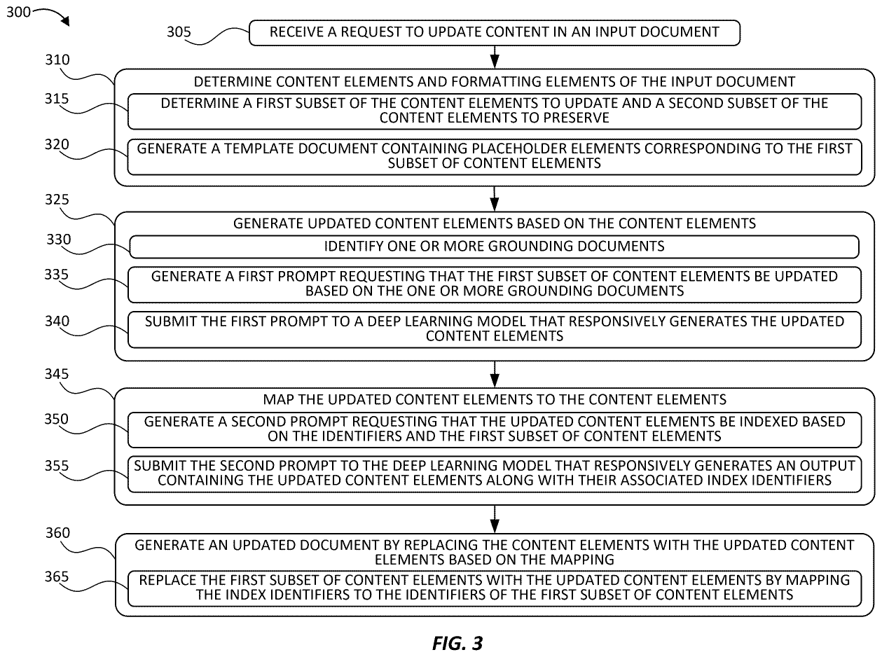

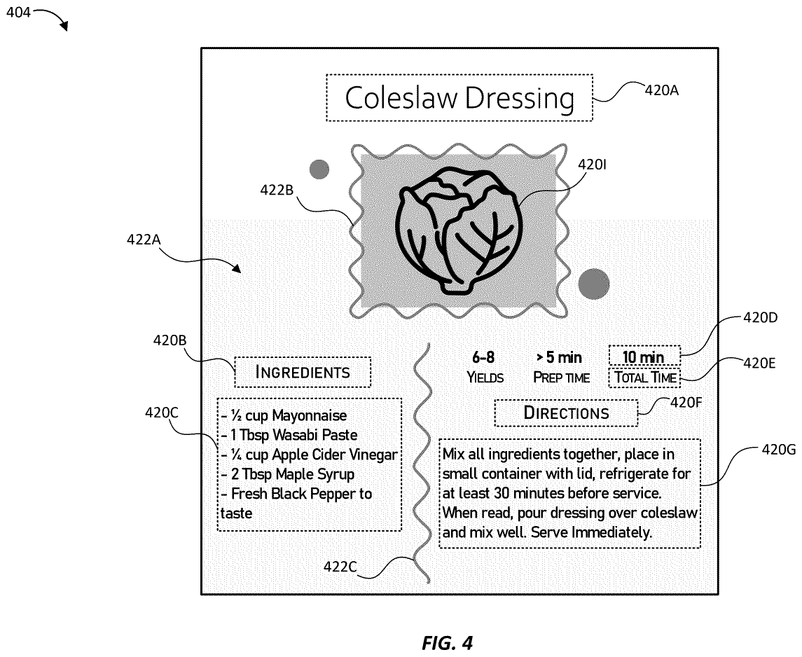

Referring now to FIG. 2, an example environment 200 in which a format reuse engine 212 is leveraged to preserve the formatting of an input document 204 during content generation is illustrated, according to an embodiment herein. For ease of explanation, FIG. 2 is described with reference to FIG. 3, which illustrates a process 300 for providing a format reuse engine and one or more of its functions, according to an embodiment herein. While FIG. 3 is described in relation to FIG. 2, it should be appreciated that the process 300 is equally applicable to the remaining figures and components therein. FIG. 2 is also described with reference to FIGS. 4-9, each of which is referenced in turn in the following description.

As illustrated, the environment 200 includes a client device 202 in operable communication with the format reuse engine 212, which may be the same as or similar to the client device 102 and the format reuse engine 112, respectively. The client device 202 is executing an application 216, such as via the application service/platform 101. The application 216 may be a productivity application, such as a word processor. As such, the application 216 renders and displays a document 204 via the client device 202, for example through the user interface 106. A user of the client device 202 may interact with the document 204—particularly the content of the document 204—to create, edit, or revise text, images, tables, or other content elements. These interactions may trigger formatting changes or invoke the format reuse engine 212, as described herein.

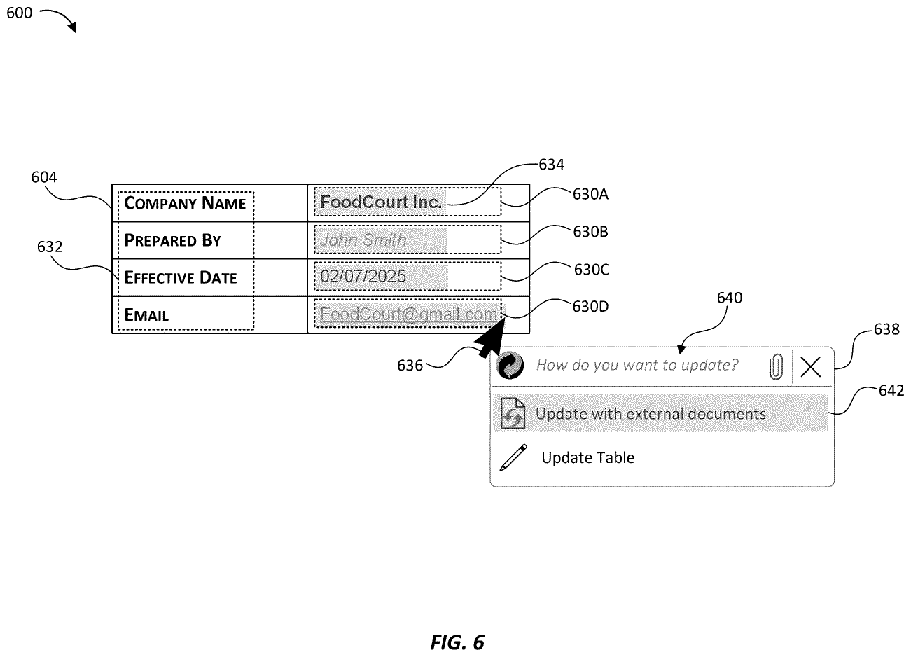

When the user interacts with the content of the document 204, the user may submit a request, such as the request 105 to update the content of the document 204 using a content generator 208. As such, the format reuse engine 212 may receive the request to update content in the document 204 (305). Since the request is to update content in the document 204, the document 204 is referred to herein as an “input document.” While the following discussions updating the content of the document 204, in some embodiments, the request 105 may be to update a portion or section of content within the document 204, such as described below with respect to FIGS. 6-8. As such, the following description is equally applicable to scenario where an entire document 204 is updated and scenarios where only a portion or section of content within the document 204 are updated.

Responsive to receiving the indication to update the content of the document 204, such as by receiving the request 105, the format reuse engine 112 may determine the content elements and formatting elements of the input document 204 (310). In particular, the format reuse engine 212 may include an element identifier 218 configured to identify content elements 220 and formatting elements 222 within the portion of content selected for updating—referred to here as the input document 204. As described above, the content elements 220 may include textual data, images, tables, lists, and other forms of structured or unstructured content that convey the substantive information of the document 204. The formatting elements 222, on the other hand, define the visual and structural presentation of the content elements 220 and may include attributes such as font type, size, color, paragraph style, indentation, alignment, and spacing.

To illustrate the content elements 220 and the formatting elements 222, reference is now made to FIG. 4. FIG. 4 illustrates an example input document 404 containing content elements and various formatting elements, according to embodiments herein. The input document 404, which may be the same or similar to the document 204, contains both content elements and formatting elements defining structure, style, and format attributes of the content elements. The content elements include content elements 422A-I and the formatting elements include formatting elements 422A-C. It should be appreciated that, for purposes of clarity and illustration, only a limited number of content elements and formatting elements are labeled in FIG. 4. However, the input document 404 may contain numerous additional content and formatting elements that are not explicitly identified in the figure.

As shown, the input document 404 pertains to a coleslaw dressing recipe. Accordingly, the input document 404 includes content elements 420A-420I that convey substantive information relevant to the preparation of coleslaw dressing. For example, content element 420A is a title—“Coleslaw Dressing”—that identifies the subject matter of the recipe. Similarly, content element 420I includes an image of cabbage, which visually reinforces the subject of the document and contributes to the overall thematic context of the input document 404.

The input document 404 also includes formatting elements 422A-422C, which define the visual style and structural layout of the document 404. For instance, formatting element 422A corresponds to the background of the input document 404, while formatting elements 422B and 422C represent visual elements that enhance the document's aesthetic appearance. Each content element 420A-420I is further associated with one or more formatting elements, which, although not individually labeled in the figure, are reflected in the visual presentation of each content element. For example, the formatting elements associated with content element 420A include the font type, font color, and font size. Similarly, the formatting elements associated with content elements 420B and 420C may include attributes such as font properties, spacing, alignment, relative positioning, and other layout features that define their structural arrangement within the document 404.

Returning to FIG. 2, if the user of client device 202 intends to update the content of the input document 404 to generate a recipe for a different food item—such as pancakes—conventional approaches would require the user to manually revise each of the content elements 220. Even with manual updates, revisions to the associated formatting elements 222 may be necessary, as structural differences between the two recipes—such as the number of ingredients, preparation steps, or layout requirements—can affect formatting. Furthermore, if the user employs the content generator 208 to perform the update, revisions to the formatting elements are often essential, as the output generated by the content generator 208 commonly does not preserve the structure, style, or formatting attributes of the original document from which the input is based upon.

Although the following discussion focuses on a recipe, it should be appreciated that the principles described are equally applicable to other types of content and subject matter, including instructional manuals, technical documentation, academic writing, business and financial reports, and marketing materials.

To preserve the formatting elements of the input document 204/404 when updating the content, the format reuse engine 212 may determine which of the content elements 220 are to be updated and which should be preserved based on the context of the input document 204/404. In particular, the format reuse engine 212 may include a content element classifier 224 configured to identify a first subset 230 of content elements 220 for updating and a second subset 232 of content elements 220 for preservation (315). The classification may be performed based on the content of the update request, the semantic and structural context of the input document 204/404, and any associated metadata. The first subset 230 may include content elements 220—such as text, images, or other media—that the content element classifier 224 determines are likely to require modification in response to the user's request. In contrast, the second subset 232 may include content elements 220 that, while substantive, serve a primarily structural or contextual role in the document 204/404. Examples of content elements 220 that may be classified into the second subset 232 include headers, titles, or section labels that define document organization but are not directly affected by the requested update. For instance, with reference to FIG. 4, the content element classifier 224 may classify content element 420C into the first subset 230 and content element 420B into the second subset 232.

In some embodiments, the content element classifier 224 parses the input document 204 and classifies the content elements 220 into a substantive content classification 226 and a structural content classification 228. The substantive content classification 226 includes content elements 230 that convey the primary subject matter or informational content of the document 204, such as narrative text, descriptive images, data tables, or procedural steps. The structural content classification 228 includes content elements 230 that serve an organizational or contextual function, such as headers, titles, labels, or section dividers, which support the document's 204 logical structure but are not themselves the focus of the substantive update. Based on these classifications 226/228, the content element classifier 224 identifies the first subset 230 (substantive content to be updated) and the second subset 232 (structural content to be preserved). To perform this classification, the content element classifier 224 may analyze the semantic context, formatting attributes, positional relationships, and user input or request data to distinguish between content elements 230 that are likely candidates for modification and those that should remain unchanged.

Upon identifying the content elements 220 and formatting elements 222—and, in some embodiments, classifying the content elements 220 into classifications 226 and 228—the format reuse engine 212 may index the content elements 220. Specifically, the format reuse engine 212 may assign a unique identifier 246, such as a tileID, to each content element 220 to facilitate indexing. In some embodiments, before performing the indexing, the format reuse engine 212 may generate a structured representation of the content elements 220, or in certain cases, of the first subset 230 of the content elements 220. For example, the format reuse engine 212 may convert the content elements 220 into an HTML format and perform indexing within the HTML representation. The following is an example structured representation of the content elements 220 from the input document 404 of FIG. 4 that is indexed and assigned unique identifiers (e.g., tileId):

| <tr> | |
|---|---|
| <td><p | tileId= “9”>Coleslaw Dressing</p></td> |
| </tr> | |
| <tr> | |
| <td><p | tileId= “14”> </p></td> |
| </tr> | |
| </table> | |
| <p tileId= | “18”> </p> |
| <table> | |
| <tr> | |
| <th> | |
| <p | tileID= “22”>Ingredients</p> |
| <p | tileID= “23”>1/2 cup</p> |
| <p | tileID= “24”>Mayonnaise</p> |
| <p | tileID= “25”>1 Tbsp</p> |
| <p | tileID= “26”>Wasabi Paste</p> |
| <p | tileID= “27”>1/4 cup</p> |
| <p | tileID= “28”>Apple Cider Vinegar</p> |
| <p | tileID= “29”>2 Tbsp</p> |
| <p | tileID= “30”>Maple Syrup</p> |
| <p | tileID= “31”>Fresh Black Pepper</p> |
| <p | tileID= “32”>to taste</p> |
| </th> | |
| <th><p | tileId=”35”></p></th> |
| <th> | |
| <p | tileId=”38”>6-8</p> |
| <p | tileId=”39”>YIELDS</p> |
| </th> | |
| <th> | |
| <p | tileId=”46”>10 Min</p> |
| <p | tileId=”47”>TOTAL TIME</p> |

```
    </th>
  <tr>
```

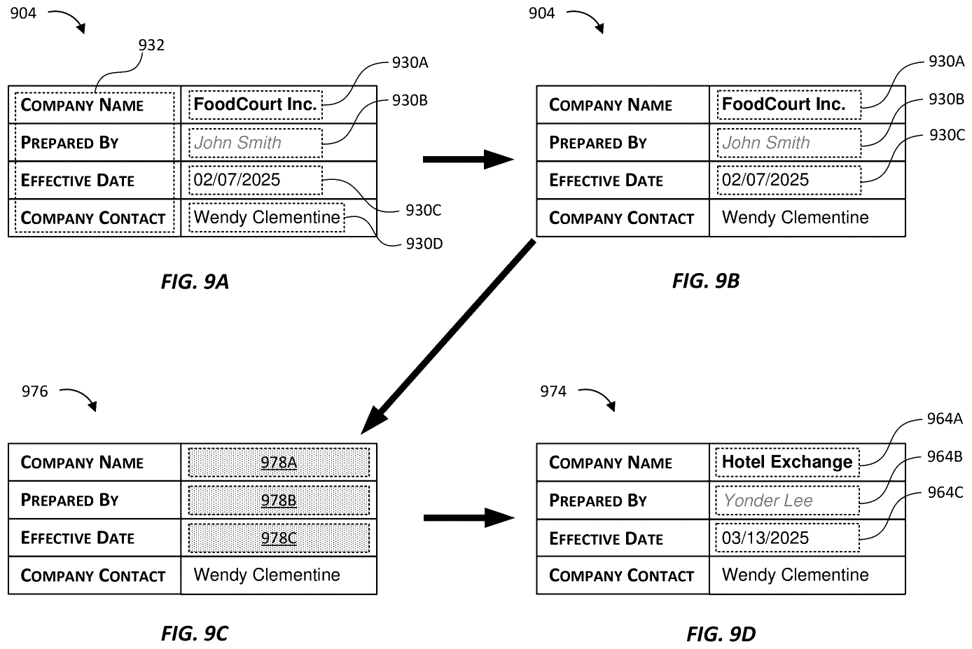

In some embodiments, responsive to classifying the content elements 230, the format reuse engine 212 may generate a template document containing placeholder elements corresponding to the content elements 230 classified into the first subset 230 (320). In an example, the format reuse engine 212 may include a template generator 248 that generates a template document 250. The template document 250 may be generated by the format reuse engine 212 and saved in one or more databases 210, which may be the same or similar to the database 110, for future use. As illustrated, the database 210 may contain stored templates 252 that may be used to generate updated documents, as described herein. Generating the template document 250 based on the content elements 230 is described in greater detail with respect to FIGS. 9A-9D.

As noted above, a request to update content within the input document 204 may involve generating new content using the content generator 208. In response, the format reuse engine 212 may generate updated content based on the content elements 220 (325). To do so, the format reuse engine 212 may identify one or more grounding documents 214 that serve as the basis for the generated content (335). In particular, the format reuse engine 212 may include a grounding source identifier 254 configured to reference the grounding documents 214 stored in the database 210. For example, as part of the update request, the user may specify one or more grounding documents 214 for the content generator 208 to use. As described in greater detail below, the user may select one or more previously stored grounding documents 256 from the database 210 for this purpose.

The grounding documents 214 may include any data that the content generator 208 can utilize to inform, support, or generate new content. Such grounding documents 214 may comprise previously authored documents, structured data sources (e.g., tables, spreadsheets, databases), unstructured text (e.g., articles, manuals, technical specifications), or other digital content relevant to the subject matter of the input document 204. The content generator 208 may analyze the grounding documents 214 to extract relevant information, context, terminology, or structure, which may then be incorporated into the generated content to improve accuracy, coherence, and domain relevance.

In some embodiments, the format reuse engine 212 may pre-process the grounding documents 214 prior to submission to the content generator 208. For example, the format reuse engine 212 may generate a structured representation of grounding content elements present within the grounding documents 214, such as converting the grounding content elements into an HTML format. The structured representation of the grounding documents 214 may retain the structural relationship of the grounding content elements as provided in a respective grounding document 214. In cases, the structured representation of the converted grounding documents 214 may be stored in the database 210 for use at a future time by the format reuse engine 212.

Once the grounding documents 214 are identified, the format reuse engine 212 may generate a first prompt 260 to initiate updating of a first subset 230 of the content elements 220 based on the grounding documents 214 (335). Specifically, the format reuse engine 212 may include a prompt generator 258 configured to construct the first prompt 260. In some implementations, the first prompt 260 may be a predefined template utilized by the format reuse engine 212 for content generation. In other implementations, the predefined prompt may be modified by a user of the client device 202, or the user may define the first prompt 260 entirely. The first prompt 260 may include instructions directing the content generator 208 to generate updated content elements 264 based on the content elements 220 and the grounding documents 214, which may be provided in a structured representation form. Additionally, the first prompt 260 may specify that the updated content elements 264 preserve the syntax, terminology, and linguistic style of the original content elements 220.

The format reuse engine 212 may provide the first prompt 260 as input to the content generator 208 (340). The content generator 208 may be implemented as a deep learning model, such as a large language model (LLM), trained on a corpus of textual data to perform natural language generation tasks. In response to receiving the first prompt 260, the content generator 208 may process the included content elements 220 to identify relevant semantic and contextual information and generate updated content elements 264 based on the grounding documents 214. Although illustrated as a component separate from the format reuse engine 212, in some embodiments, the content generator 208 may be integrated with the format reuse engine 212.

In some embodiments, the first prompt 260 instructs the content generator 208 to generate the updated content elements 264 based on the grounding documents 214 while maintaining the logical structure (e.g., headings, paragraphs, lists) of the input document 204. In such cases, the first prompt 260 may include a structured representation of the content elements 220. The first prompt 260 may not require the content generator 208 to replicate specific formatting elements 222 (e.g., number of elements, unique identifiers), but may instead specify that the semantic structure of the updated content elements 264 correspond to the structure defined by the structured representation.

Due to the absence of strict formatting constraints, the updated content elements 264 may be generated in a free-form structure, allowing the content generator 208 to prioritize the quality and relevance of the output relative to the content elements 220. Imposing rigid constraints—such as requiring the content generator 208 to match specific formatting elements (e.g., the number of items in a list or entries in a table)—may lead to undesirable outcomes. For example, the content generator 208 may introduce hallucinated elements to satisfy structural requirements that are not supported by the grounding documents 214, or it may omit or truncate relevant information in order to conform to the structure of the original content elements 220.

Responsive to receiving the first prompt 260, the content generator 208 generates the updated content elements 264 and provides the updated content elements 264 as an output to the format reuse engine 212. In some embodiments, the first prompt 260 may request that the output from the content generator 208 be generated in a structured representation matching the input content. Following the above example, if the structured representation in an HTML format of the content elements 220 is provided as part of the first prompt 260, the output may be a structured representation in an HTML format of the updated content elements 264. The following is an example output that the content generator 208 generated based on the above structured representation of the content elements 220 from the input document 404 and grounding documents 214 on how to make pancakes:

```
<tr>
  <td><p>Pancake Procedure</p></td>
</tr>
</table>
<p> This professional manual details the precise steps for
crafting pancakes, ensuring a delightful breakfast option
with consistent results. </p>
<table>
  <tr>
    <th>
      <p>Ingredients</p>
      <p>1 cup</p>
      <p>All-Purpose Flour</p>
      <p>2 Tbsp</p>
      <p>Granulated sugar</p>
      <p>1 tsp</p>
      <p>Salt</p>
      <p>1 cup</p>
      <p>Buttermilk</p>
      <p>1/4 cup</p>
      <p>2% Milk</p>
      <p>1 Large</p>
      <p>Egg</p>
      <p>2 Tbsp</p>
      <p>Unsalted Butter, </p>
      <p>melted</p>
    </th>
    <th><p></p></th>
    <th>
      <p>Serves 4</p>
      <p>YIELDS</p>
    </th>
    <th>
      <p>20 Min</p>
      <p>Prep Time</p>
    </th>
  <tr>
```

Because the updated content elements 264 are generated in a free-form format, the format reuse engine 212 may map the updated content elements 264 to the content elements 220 (345). In particular, the format reuse engine 212 may include a mapper 268 that generates a mapping 270 of the updated content elements 264 to the content elements 220. To map the updated contents 264 to the content elements 220, the prompt generator 258 may generate a second prompt 262 requesting that the updated content elements 264 be indexed based on the identifiers 246 of the content elements 220 (350). That is, the second prompt 262 may include the structured representation with the identifiers 246 and the updated content elements 264 previously received from the content generator 208.

The format reuse engine 212 then submits the second prompt 262 to the content generator 208 which may responsively generate an output containing the updated content elements 264 with associated index identifiers 266 (355). That is, based on the identifiers 246 of the content elements 220 provided in the second prompt 262, the content generator 208 may generate and assign index identifiers 266 to the updated content elements 264. Following the above example, the following is an example output from the content generator 208:

| <tr> | |
|---|---|
| <td><p | tileId=”14”>Pancake Procedure</p></td> |
| </tr> | |
| </table> | |
| <p tileId=”18”> This professional manual details the precise | |
| steps for crafting pancakes, ensuring a delightful breakfast | |
| option with consistent results. </p> | |
| <table> | |
| <tr> | |
| <th> | |
| <p | tileId=”22”>Ingredients</p> |
| <p | tileId=”23”>1 cup</p> |
| <p | tileId=”24”>All-Purpose Flour</p> |
| <p | tileId=”25”>2 Tbsp</p> |
| <p | tileId=”26”>Granulated sugar</p> |
| <p | tileId=”27”>1 tsp</p> |
| <p | tileId=”28”>Salt</p> |
| <p | tileId=”29”>1 cup</p> |
| <p | tileId=”30”>Buttermilk</p> |
| <p | tileId=”31”>1/4 cup</p> |
| <p | tileId=”32”>2% Milk</p> |
| <p | tileId=”new”>1 Large</p> |
| <p | tileId=”new”>Egg</p> |
| <p | tileId=”new”>2 Tbsp</p> |
| <p | tileId=”new”>Unsalted Butter, </p> |
| <p | tileId=”new”>melted</p> |
| </th> | |
| <th><p></p></th> | |
| <th> | |
| <p | tileId=”38”>Serves 4</p> |
| <p | tileId=”39”>YIELDS</p> |
| </th> | |
| <th> | |
| <p | tileId=”46”>20 Min</p> |
| <p | tileId=”47”>Prep Time</p> |

```
    </th>
  <tr>
```

In response to receiving the second prompt 262, the content generator 208 outputs the updated content elements 264 along with corresponding index identifiers 266. The index identifiers 266 may correspond to the identifiers 246 of the original content elements 220. However, in some scenarios, the quantity of updated content elements 264 may differ from the original content elements 220. As a result, the content generator 208 may be unable to associate each updated content element 264 with a corresponding identifier 246. For example, if there are more updated content elements 264 than original content elements 220, the content generator 208 may assign the index identifier 266 value “new” to each additional content element that lacks a corresponding identifier 246. Conversely, if there are fewer updated content elements 264 than original content elements 220, the content generator 208 may disregard the identifiers 246 that do not have a corresponding updated content element 264. In some cases, the content generator 208 may tag the identifiers 246 that do not have a corresponding content element 264 to indicate that the respective content elements should be removed in the updated document.

Using the index identifiers 266, the mapper 268 may map the updated content elements 264 to the content elements 220, such as by generating a mapping 270. Using the mapping 270, which may be the output from the content generator 208, the format reuse engine 212 may generate an updated document 274 by replacing the content elements 220 with the updated content elements 264 based on the mapping 270 (360). In particular, the format reuse engine 212 may include a document updater 272 that generates the updated document 274 by replacing the content elements 220, or in certain cases the first subset 230, with the updated content elements 264 by mapping the index identifiers 266 to the identifiers 246 of the content elements 220 (365).

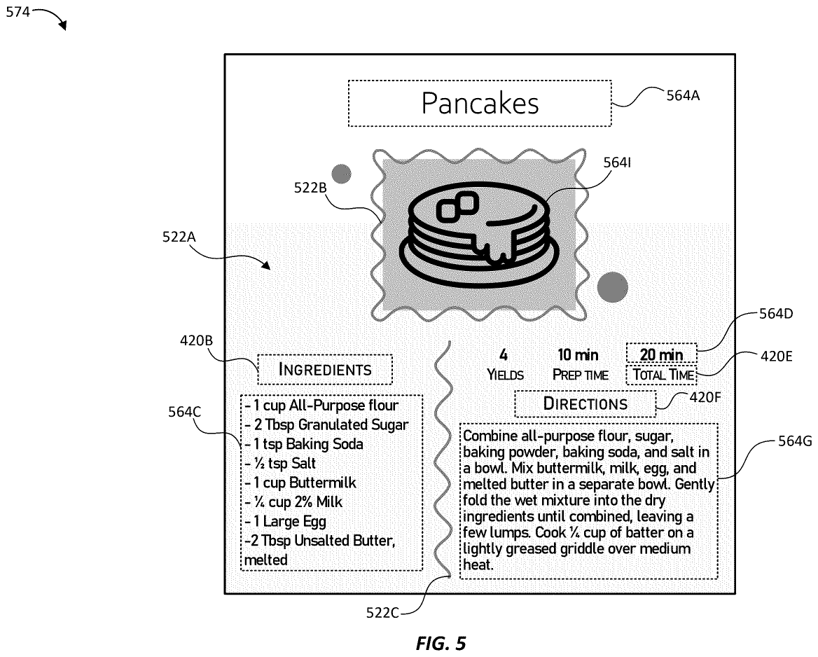

Referring now to FIG. 5, an example updated document 574 is illustrated, according to an embodiment herein. The updated document 574 is generated by the format reuse engine 212 based on the structured representation, including the index identifiers 266 that map the updated content elements 264 to the first subset 230 of the content elements 220 from the input document 404. As illustrated, the first subset 230 includes the content elements 420A, 420C-420D, and 420G-420I, which were identified as containing substantive information for the update. Accordingly, the first prompt 260 identified the content elements 420A, 420C-D and 420G-420I for updating, while maintaining the content elements 420B and 420E-420F as the second subset 232. For example, the format reuse engine 212 identified the ingredient list (e.g., the content element 420A) for revision, while maintaining the “Ingredients” header (e.g., the content element 420B). In addition to the text-based content elements, the format reuse engine 212 also updated the image-based content element 420I to reflect the updated content element 564I.

As further illustrated, the format reuse engine 212 updated the content elements 220 while preserving the formatting elements 522A-522C, as well as the unlabeled formatting elements of the content elements 220. Accordingly, the content elements 220 are updated based on the updated content elements 264, which are mapped by the index identifiers 266, while the overall formatting of the input document 404 is preserved. As shown, the font, font size, spacing, and other formatting attributes remain consistent in the updated document 574, while the substantive information is updated with the updated content elements 564A, 564C-D, and 564G-I.

Referring now to FIGS. 6-8, an illustrative user-interface flow for using the format reuse engine 212 is illustrated. FIG. 6 provides an example graphical user-interface (GUI) 600 provided to a user of a client device, such as the client device 102, according to various embodiments herein. The GUI 600 includes input content 604 that the user has selected for revision. As noted above, in some embodiments, instead of revising an entire document, such as the input document 404, a user may select a portion or segment of the document, such as the input content 604.

As shown, the user may use a cursor 636 to highlight 634 a portion of the input content 604. Responsive to the selection with the cursor 636, a prompt 638 may be displayed via the GUI 600. The prompt 638 may include an input field 640 via which the user may insert text indicating what revisions are desired within the input content 604. In addition to the input filed 640, the prompt 638 may also include a dropdown that provides various options for the update. As illustrated, the user may select the option 642 to update the table with documents external to the input content 604.

Responsive to the selection of the highlighted content 634 and/or the option 642, the format reuse engine 212 may parse the input content 604 to determine the content elements 220 and the formatting elements 222, as described above. The format reuse engine 212 may also classify the content elements 220 into substantive content elements 630A-D and structural content elements 632. As described above, the format reuse engine 212 determines which of the content elements 220 should be updated in the input content 604 and which should be preserved. In the illustrated example, the format reuse engine 212 identifies the row headers as structural content elements 632 and the associated fields 630A-D as substantive content elements 630A-D.

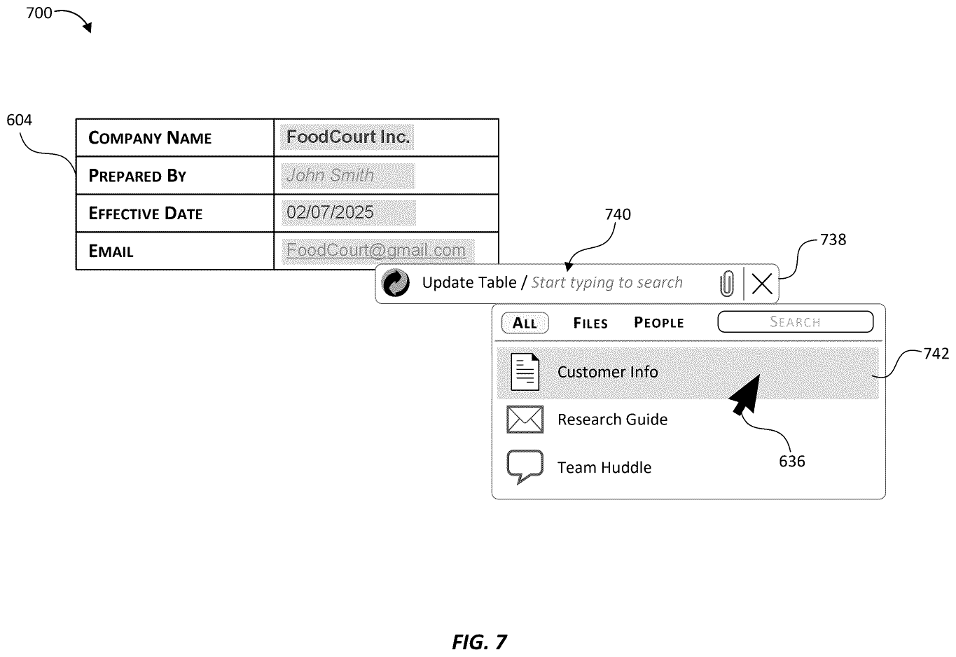

Referring now to FIG. 7, an example GUI 700 illustrating a subsequent view of the GUI 600 responsive to a request to update the input content 604 is provided, according to an embodiment herein. As illustrated, when the user selects the option 642 to update the input content 604, a prompt 738 is provided for selecting which sources to use for the update. The prompt 738 includes an input field 740 into which the user can type or search for a respective grounding document. The prompt 738 may also include a dropdown menu that provides grounding documents that may be relevant to the user. As illustrated, the user may make a selection 742 of a desired grounding document using the cursor 636.

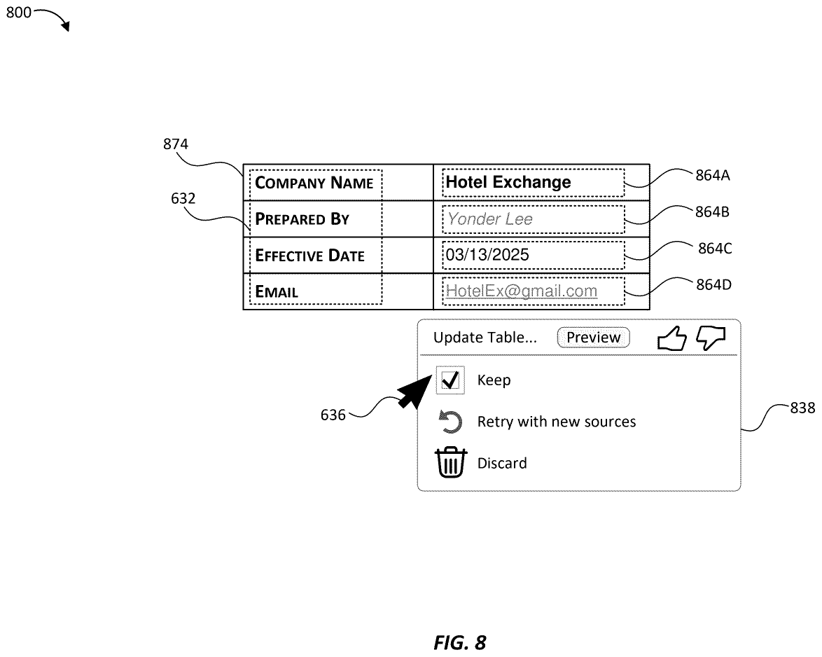

Once the user selects one or more grounding documents, the format reuse engine 212 generates updated content based on the input content 604 and the selected grounding documents, as described above. Referring now to FIG. 8, an example GUI 800 illustrating an example updated content 874 of the input content 604 is provided, according to an embodiment herein. As shown, the substantive content elements 630A-D are replaced with updated content elements 864A-D, respectively, while the structural content elements 632 are maintained. Additionally, the formatting elements (e.g., font style, font color, text size) of the substantive content elements 630A-D are preserved and applied to the updated content elements 864A-D.

In some embodiments, when the format reuse engine 212 generates the updated content 874, a prompt 838 is presented to the user, allowing for validation of the updated content elements 964A-D and/or enabling interaction with the generated updated content 874. Specifically, the prompt 838 provides the user with multiple options: (i) accept the updated content 874, (ii) to revise one or more elements of the updated content elements 864A-864D based on newly selected or modified grounding documents (e.g., source materials), or (iii) to discard the updated content 874 entirely if it is deemed unsuitable or irrelevant. This functionality allows the user to maintain control over the integration of content updates.

Referring now to FIGS. 9A-9D, an example flow for generating a template document from an input document or input content is illustrated, according to various embodiments described herein. FIG. 9A depicts the input content 904, from which the format reuse engine 212 identifies substantive content elements 930A-930D and structural content elements 932. In some embodiments, the input content 904 and the identification of the substantive content elements 930A-930D may be presented to a user of the client device 202. Specifically, upon receiving the input content 904, the format reuse engine 212 may parse the input content 904 to determine which content elements 220 should be updated—such as the substantive content elements 930A-930D. To facilitate user review and verification, the format reuse engine 212 may visually highlight or otherwise indicate the substantive content elements 930A-930D, enabling the user to confirm or validate whether the classification of those elements is accurate.

FIG. 9B illustrates that the user indicated that the substantive content element 930D was incorrectly classified and thus should be classified as a structural content element. As such, the substantive content element 930D is removed from the substantive content classification. From there, the format reuse engine 212 may generate a template document 976, as illustrated in FIG. 9C. To generate the template document 976, the format reuse engine 212 may replace the substantive content elements 930A-C with placeholder elements 978A-C. The template document 976 may then be saved to the database 210 as a stored template 252 for future use.

At a later time, a user may retrieve or otherwise identify the template document 976 for updating. FIG. 9D illustrates an updated document 974 generated by the format reuse engine 212 that updates the template document 976. In particular, the format reuse engine 212 replaces the placeholder elements 978A-C with updated content elements 964A-C. As illustrated, the formatting elements are preserved for the updated content elements 964A-C, thereby minimizing rework of any formatting by the user for generation of the updated content 974.

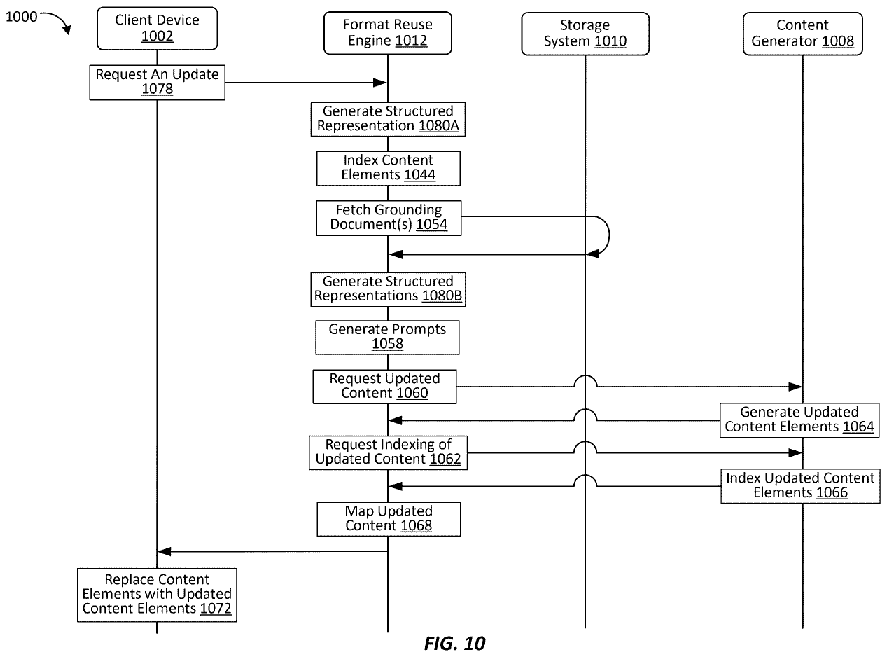

Referring now to FIG. 10, an example flow 1000 for providing one or more functions of a format reuse engine 1012 is illustrated, according to an embodiment herein. As shown, the flow 1000 may initiate with a client device 1002, which may be the same or similar to the client device 202, requesting an update to content or a document (1078), such as the input document 204 or the input content 604. The format reuse engine 1012 may receive the request from the client device 1002 and responsively analyze the input document/content to determine the content elements and the formatting elements therein. As noted above, in some cases, the format reuse engine 1012 may classify the content elements to determine a subset of content elements for updating and a subset for preservation.

Once the content are elements identified, the format reuse engine 1012 generates a structured representation of the input document/content (1080A). In some cases, the structure representation may be an HTML format of the input document/content or the content elements. The format reuse engine 1012 may then index the content elements within the structure representation, such as by assigning unique identifiers to the content elements (1044).

As noted above, the request to update the input document/content may identify one or more grounding documents from which the update is generated. As such, the format reuse engine 1012 may query a storage system 1010, which may be the same or similar to the database 210, to fetch the identified grounding documents (1054). Once retrieved, the format reuse engine 1012 may generate a structured representation of each of the grounding documents (1080B). For example, the format reuse engine 1012 may convert the grounding documents into an HTML format. It should be appreciated that while the fetching and converting of the grounding documents is illustrated as subsequent to the generating the structured representation of the content elements and indexing the content elements, these steps may be performed in parallel or in any other order.

Subsequently, the format reuse engine 1012 may generate one or more prompts (1058). As noted above, this may include generating a first prompt requesting updated content be generated based on the structured representations of the content elements and grounding documents. The first prompt may be submitted to a content generator 1008, which may responsively generate updated content elements (1064) and return the updated content elements to the format reuse engine 1012. The updated content elements may be unstructured such to be mismatching with the structure of the input document/content. As such, the format reuse engine 1012 may generate a second prompt requesting indexing of the updated content elements (1062). The second prompt may include the updated content elements previously received from the content generator 1008 and the indexed content elements.

Responsive to receiving the second prompt, the content generator 1008 may index the updated content elements (1066). This may include generating and assigning index identifiers to the updated content elements that correspond to the identifiers assigned to the content elements within the structured representation. Once indexed, the updated content elements are returned to the format reuse engine 1012. Using the index identifiers received from the content generator 1008, the format reuse engine 1012 maps the updated content elements to the indexed content elements (1068). The format reuse engine 1012 then provides the mapping of the updated content elements to the indexed content elements to the client device 1002. Specifically, the mapping is provided to the application executing the input content/document on the client device 1002. Using the mapping, the application replaces the content elements with the updated content elements (1072), thereby generating the updated document/content.

Referring to FIG. 11, FIG. 11 illustrates a system 1100 including a computing apparatus 1191 that may be used for providing or interacting with a format reuse engine and related functions, as described herein. For example, the client devices 102, 202, and 1002 may comprise or be implemented as instances of the computing apparatus 1191. Alternatively, a server or other type of computing resource that provides the functionality of the format reuse engine may comprise or include the computing apparatus 1191. As illustrated, the computing apparatus 1191 includes a processing system 1192 that includes a microprocessor and other circuitry that retrieves and executes software 1195 from storage system 1193. The processing system 1192 may be implemented within a single processing device but may also be distributed across multiple processing devices or sub-systems that cooperate in executing program instructions. Examples of the processing system 1192 include general purpose central processing units, graphical processing units, application specific processors, and logic devices, as well as any other type of processing device, combinations, or variations thereof.

The storage system 1193 may comprise any computer-readable storage media or medium readable by processing system 1192 and capable of storing software 1195. The storage system 1193 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 1193 may also include computer readable communication media over which at least some of the software 1195 may be communicated internally or externally. The storage system 1193 may be implemented as a single storage device but may also be implemented across multiple storage devices or sub-systems co-located or distributed relative to each other. The storage system 1193 may comprise additional elements, such as a controller capable of communicating with the processing system 1192 or possibly other systems.

The software 1195 (including format reuse engine 1196) may be implemented in program instructions and among other functions may, when executed by the processing system 1192, direct the processing system 1192 to operate as described with respect to the various operational scenarios, sequences, and processes illustrated herein. For example, the software 1195 may include program instructions for implementing a format reuse engine and related functions, such as the process 300 or the operational flow 1000, as described herein. In some cases, the software 1195 may cause one or more features of the format reuse engine process 1196 to provide or display respective components to a user via a user interface system 1199 inoperable communication with a client device, such as the updated document 274 to the client device 202.

As used herein, the term “engine” as used herein includes a “component”, “module”, “system,” and the like is intended to refer to a computer-related entity, either software-executing general-purpose processor, hardware, firmware and a combination thereof. For example, an engine may be, but is not limited to being, a process running on a hardware processor, a hardware-based processor, an object, an executable, a thread of execution, a program, and/or a computer.

The program instructions of the software 1195 may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 1195 may include additional processes, programs, or components, such as operating system software, virtualization software, or other application software. The software 1195 may also comprise firmware or some other form of machine-readable processing instructions executable by the processing system 1192.

In general, the software 1195 may, when loaded into the processing system 1192 and executed, transform a suitable apparatus, system, or device (of which computing apparatus 1191 is representative) overall from a general-purpose computing system into a special-purpose computing system customized to generate features, functionality, and user experiences provided by the format reuse engine. Indeed, encoding the software 1195 on the storage system 1193 may transform the physical structure of the storage system 1193. The specific transformation of the physical structure may depend on various factors in different implementations of this description. Examples of such factors may include, but are not limited to, the technology used to implement the storage media of the storage system 1193 and whether the computer-storage media are characterized as primary or secondary storage, as well as other factors.

For example, if the computer readable storage media are implemented as semiconductor-based memory, the software 1195 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1197 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 1191 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA), graphics processing units (GPUs), or neural processing units (NPUs) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), FPGAs, GPUs, NPUS, and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a format reuse engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage media comprising processor-executable instructions stored thereon; and a processor coupled to the computer-readable storage media and configured to execute the processor-executable instructions that, when executed by the processor, direct the computing apparatus to at least: identify an input document for content updating; determine a plurality of content elements and a plurality of formatting elements defining the format, style, and structure of the plurality of content elements within the input document; determine a first subset of content elements for updating and a second subset of content elements for preservation, wherein the plurality of content elements comprises the first subset of content elements and the second subset of content elements; identify one or more grounding documents; generate a plurality of updated content elements based on the first subset of content elements and the one or more grounding documents; and generate an updated document by replacing the first subset of content elements with the updated content elements, wherein the updated document preserves the plurality of formatting elements such that the plurality of formatting elements defines the format, style, and structure of the plurality of updated content elements.

Example 2 is the computing apparatus of any previous or subsequent Example, wherein the processor-executable instructions to generate the plurality of updated content elements based on the first subset of content elements and the one or more grounding documents, when executed by the processor, further direct the computing apparatus to: submit, to a deep learning model, an input requesting updated content, wherein the input comprises the one or more grounding documents and the first subset of content elements; and receive the plurality of updated content elements as an output from the deep learning model.

Example 3 is the computing apparatus of any previous or subsequent Example, wherein: the processor-executable instructions, when executed by the processor, further direct the computing apparatus to: index the first subset of content elements by assigning a plurality of identifiers to the first subset of content elements, wherein each content element of the subset of content elements is assigned a respective identifier of the plurality of identifiers; submit, to a deep learning model, a request to generate a mapping of the plurality of updated content elements to the first subset of content elements; and the processor-executable instructions to generate the updated document by replacing the first subset of content elements with the updated content elements, when executed by the processor, further direct the computing apparatus to: replace the first subset of content elements with the updated content elements based on the mapping of the plurality of updated content elements and the plurality of identifiers.

Example 4 is the computing apparatus of any previous or subsequent Example, wherein the processor-executable instructions to determine the first subset of content elements for updating and the second subset of content elements for preservation, when executed by the processor, further direct the computing apparatus to: generate a template document based on the input document, wherein the template document identifies the first subset of content elements for updating and the second subset of content elements for preservation.

Example 5 is the computing apparatus of any previous or subsequent Example, wherein the processor-executable instructions, when executed by the processor, further direct the computing apparatus to: store the template document to a database at a first time; receive, at a subsequent second time, an indication to generate a second updated document using the template document; identify one or more additional grounding documents; generate a second plurality of updated content elements based on the first subset of content elements and the one or more additional grounding documents; and generate the second updated document by replacing the first subset of content elements with the second plurality of updated content elements.

Example 6 is the computing apparatus of any previous or subsequent Example, wherein the processor-executable instructions to determine the first subset of content elements for updating and the second subset of content elements for preservation, when executed by the processor, further direct the computing apparatus to: classify the plurality of content elements in the input document into: a substantive content classification comprising content elements that contain substantive content; and a structural content classification comprising content elements that define document structure; identify, from the substantive content classification, the first subset of content elements; and identify, from the structural content classification, the second subset of content elements.

Example 7 is a method comprising: receiving, from a client device, a request to update content within an input document, wherein the input document comprises a plurality of content elements and a plurality of formatting elements defining the format, style, and structure of the plurality of content elements within the input document; assigning, by a format reuse engine, a plurality of identifiers to the plurality of content elements, wherein an identifier is assigned to each content element of the plurality of content elements; identifying, by the format reuse engine, one or more grounding documents for updating the content within the input document; generating, by the format reuse engine, a plurality of updated content elements based on the one or more grounding documents; mapping, by the format reuse engine, the plurality of updated content elements to the plurality of content elements using the plurality of identifiers; and generating, by the format reuse engine, an updated document by replacing the plurality of content elements with the plurality of updated content elements based on the mapping, wherein the updated document preserves the plurality of formatting elements of the input document.

Example 8 is the method of any previous or subsequent Example, wherein generating the plurality of updated content elements based on the one or more grounding documents comprises: generating, by the format reuse engine, a structured representation of the plurality of content elements, wherein the structured representation retains a structural relationship of the plurality of content elements as provided in the input document; submitting, to a large language model (LLM) associated with the format reuse engine, the structured representation of the plurality of content elements and the one or more grounding documents as an input; and receiving, by the format reuse engine, the plurality of updated content elements as an output from the LLM.

Example 9 is the method of any previous or subsequent Example, wherein generating the plurality of updated content elements based on the one or more grounding documents comprises: submitting, to a large language model (LLM) associated with the format reuse engine, the plurality of content elements and the one or more grounding documents as an input; receiving, by the format reuse engine, a plurality of updated content elements as an output from the LLM, wherein: the plurality of content elements is generated by the LLM responsive to receiving the input; and the plurality of content elements is unstructured; submitting, to the LLM, a request to index the plurality of updated content elements based on the plurality of identifiers and the plurality of content elements; and receiving, by the format reuse engine, the plurality of updated content elements comprising a plurality of index identifiers, wherein the plurality of index identifiers corresponds to the plurality of identifiers assigned to the plurality of content elements.

Example 10 is the method of any previous or subsequent Example, wherein mapping the plurality of updated content elements to the plurality of content elements based on the plurality of identifiers assigned to the plurality of content elements comprises: determining, by the format reuse engine, that a number of elements in the plurality of updated content elements is less than a number of content elements in the plurality of content elements; identifying, by the format reuse engine, one or more extra content elements of the plurality of content elements lacking a corresponding updated content element; and tagging, by the format reuse engine, the one or more extra content elements for removal when replacing the plurality of content elements with the plurality of updated content elements in the updated document.

Example 11 is the method of any previous or subsequent Example, wherein mapping the plurality of updated content elements to the plurality of content elements based on the plurality of identifiers assigned to the plurality of content elements comprises: determining, by the format reuse engine, that a number of elements in the plurality of updated content elements is greater than a number of content elements in the plurality of content elements; identifying, by the format reuse engine, one or more additional updated content elements from the plurality of updated content elements lacking a corresponding content element of the plurality of content elements; and assigning, by the format reuse engine, one or more additional identifiers to the one or more additional updated content elements.

Example 12 is the method of any previous or subsequent Example, wherein identifying, by the format reuse engine, the one or more grounding documents for updating the content within the input document further comprises: receiving, by the format reuse engine, a selection of the one or more grounding documents from the client device, wherein each grounding document comprises a plurality of grounding content elements; and generating, by the format reuse engine, a structured representation of the one or more grounding documents, wherein the structured representation retains a structural relationship of the plurality of grounding content elements as provided in a respective grounding document.

Example 13 is the method of any previous or subsequent Example, wherein receiving the request to update content within the input document further comprises: receiving, from the client device, an indication to update a subset of content within the input document, wherein the subset of content comprises the plurality of content elements.

Example 14 is the method of any previous or subsequent Example, wherein the method further comprises: generating, by the format reuse engine, a template document based on the input document, wherein: the template document comprises a plurality of placeholder elements and the plurality of formatting elements defining the format, style, and structure of the plurality of placeholder elements; and a placeholder element of the plurality of placeholder elements corresponds to a respective content element of the plurality of content elements as provided in the input document; and inserting, by the format reuse engine, the plurality of updated content elements into the plurality of placeholder elements of the template document; and validating, by the format reuse engine, the plurality of updated content elements as inserted into the plurality of placeholder elements, wherein the updated document is generated based on validation of the plurality of updated content elements as inserted into the plurality of placeholder elements.

Example 15 is a computer readable storage media comprising processor-executable instructions configured to cause a processor to: receive, by a format reuse engine, a request to update content within an input document; identify, by the format reuse engine, a plurality of content elements and a plurality of formatting elements defining the format, style, and structure of the plurality of content elements within the input document; determine, by the format reuse engine, a first subset of content elements for updating and a second subset of content elements for preservation, wherein the plurality of content elements comprises the first subset of content elements and the second subset of content elements; identify, by the format reuse engine, one or more grounding documents; generate, by the format reuse engine, a plurality of updated content elements based on the first subset of content elements and the one or more grounding documents; and generate, by the format reuse engine, an updated document by replacing the first subset of content elements with the updated content elements, wherein the updated document preserves the plurality of formatting elements such that the plurality of formatting elements defines the format, style, and structure of the plurality of updated content elements.

Example 16 is the computer readable storage media of any previous or subsequent Example, wherein: the processor-executable instructions to generate, by the format reuse engine, the plurality of updated content elements based on the first subset of content elements and the one or more grounding documents cause the processor to further execute processor-executable instructions stored in the computer readable storage media to: generate, by the format reuse engine, a structured representation of the first subset of content elements, wherein the structured representation retains a structural relationship of the first subset of content elements as provided in the input document; submit, to a deep learning model in operable communication with the format reuse engine, the structured representation of the first subset of content elements and the one or more grounding documents as an input; and receive, by the format reuse engine, the plurality of updated content elements as an output from the deep learning model.

Example 17 is the computer readable storage media of any previous or subsequent Example, wherein the processor-executable instructions cause the processor to further execute processor-executable instructions stored in the computer readable storage media to: assign, by the format reuse engine, a plurality of identifiers to the first subset of content elements, wherein an identifier is assigned to each content element of the first subset of content elements; and map, by the format reuse engine, the plurality of updated content elements to the first subset of content elements based on the plurality of identifiers assigned to the plurality of content elements.

Example 18 is the computer readable storage media of any previous or subsequent Example, wherein the processor-executable instructions to determine, by the format reuse engine, the first subset of content elements for updating and the second subset of content elements for preservation cause the processor to further execute processor-executable instructions stored in the computer readable storage media to: classify, by the format reuse engine, the plurality of content elements in the input document into: a substantive content classification comprising content elements that contain substantive content; and a structural content classification comprising content elements that define document structure; identify, by the format reuse engine, the first subset of content elements from the substantive content classification; and identify, by the format reuse engine, the second subset of content elements from the structural content classification. Example 19 is the computer readable storage media of any previous or subsequent Example, wherein the processor-executable instructions to generate, by the format reuse engine, the plurality of updated content elements based on the first subset of content elements and the one or more grounding documents cause the processor to further execute processor-executable instructions stored in the computer readable storage media to: submit, to a deep learning model in operable communication with the format reuse engine, the first subset of content elements and the one or more grounding documents as an input; receive, by the format reuse engine, a plurality of updated content elements as an output from the deep learning model, wherein: the plurality of content elements is generated by the deep learning model responsive to receiving the input; and a structure of the plurality of content elements is unmatched from a structure of the first subset of content elements; submit, to the deep learning model, a request to index of the plurality of updated content elements based the first subset of content elements; and receive, by the format reuse engine, the plurality of updated content elements comprising a plurality of index identifiers, wherein the plurality of index identifiers corresponds to a respective content element of the first subset of content elements.

Example 20 is the computer readable storage media of any previous or subsequent Example, wherein the processor-executable instructions cause the processor to further execute processor-executable instructions stored in the computer readable storage media to: generate, by the format reuse engine, a template document based on the input document, wherein: the template document comprises a plurality of placeholder elements and the plurality of formatting elements defining the format, style, and structure of the plurality of placeholder elements; and a placeholder element of the plurality of placeholder elements corresponds to a content element of the first subset of content elements as provided in the input document; and save, by the format reuse engine, the template document to a template database.

What is claimed is:

1. A computing apparatus comprising:
a computer-readable storage media comprising processor-executable instructions stored thereon; and
a processor coupled to the computer-readable storage media and configured to execute the processor-executable instructions that, when executed by the processor, direct the computing apparatus to at least:
identify an input document for content updating;
determine a plurality of content elements and a plurality of formatting elements defining the format, style, and structure of the plurality of content elements within the input document;
determine a first subset of content elements for updating and a second subset of content elements for preservation, wherein the plurality of content elements comprises the first subset of content elements and the second subset of content elements;
identify one or more grounding documents;
generate a plurality of updated content elements based on the first subset of content elements and the one or more grounding documents; and
generate an updated document by replacing the first subset of content elements with the updated content elements, wherein the updated document preserves the plurality of formatting elements such that the plurality of formatting elements defines the format, style, and structure of the plurality of updated content elements.

2. The computing apparatus of claim 1, wherein the processor-executable instructions to generate the plurality of updated content elements based on the first subset of content elements and the one or more grounding documents, when executed by the processor, further direct the computing apparatus to:
submit, to a deep learning model, an input requesting updated content, wherein the input comprises the one or more grounding documents and the first subset of content elements; and
receive the plurality of updated content elements as an output from the deep learning model.

3. The computing apparatus of claim 1, wherein:
the processor-executable instructions, when executed by the processor, further direct the computing apparatus to:
index the first subset of content elements by assigning a plurality of identifiers to the first subset of content elements, wherein each content element of the subset of content elements is assigned a respective identifier of the plurality of identifiers;
submit, to a deep learning model, a request to generate a mapping of the plurality of updated content elements to the first subset of content elements; and
the processor-executable instructions to generate the updated document by replacing the first subset of content elements with the updated content elements, when executed by the processor, further direct the computing apparatus to:
replace the first subset of content elements with the updated content elements based on the mapping of the plurality of updated content elements and the plurality of identifiers.

4. The computing apparatus of claim 1, wherein the processor-executable instructions to determine the first subset of content elements for updating and the second subset of content elements for preservation, when executed by the processor, further direct the computing apparatus to:
generate a template document based on the input document, wherein the template document identifies the first subset of content elements for updating and the second subset of content elements for preservation.

5. The computing apparatus of claim 4, wherein the processor-executable instructions, when executed by the processor, further direct the computing apparatus to:
store the template document to a database at a first time;
receive, at a subsequent second time, an indication to generate a second updated document using the template document;
identify one or more additional grounding documents;
generate a second plurality of updated content elements based on the first subset of content elements and the one or more additional grounding documents; and
generate the second updated document by replacing the first subset of content elements with the second plurality of updated content elements.

6. The computing apparatus of claim 1, wherein the processor-executable instructions to determine the first subset of content elements for updating and the second subset of content elements for preservation, when executed by the processor, further direct the computing apparatus to:
classify the plurality of content elements in the input document into:
a substantive content classification comprising content elements that contain substantive content; and
a structural content classification comprising content elements that define document structure;
identify, from the substantive content classification, the first subset of content elements; and
identify, from the structural content classification, the second subset of content elements.

7. A method comprising:
receiving, from a client device, a request to update content within an input document, wherein the input document comprises a plurality of content elements and a plurality of formatting elements defining the format, style, and structure of the plurality of content elements within the input document;
assigning, by a format reuse engine, a plurality of identifiers to the plurality of content elements, wherein an identifier is assigned to each content element of the plurality of content elements;
identifying, by the format reuse engine, one or more grounding documents for updating the content within the input document;
generating, by the format reuse engine, a plurality of updated content elements based on the one or more grounding documents;
mapping, by the format reuse engine, the plurality of updated content elements to the plurality of content elements using the plurality of identifiers; and
generating, by the format reuse engine, an updated document by replacing the plurality of content elements with the plurality of updated content elements based on the mapping, wherein the updated document preserves the plurality of formatting elements of the input document.

8. The method of claim 7, wherein generating the plurality of updated content elements based on the one or more grounding documents comprises:
generating, by the format reuse engine, a structured representation of the plurality of content elements, wherein the structured representation retains a structural relationship of the plurality of content elements as provided in the input document;
submitting, to a large language model (LLM) associated with the format reuse engine, the structured representation of the plurality of content elements and the one or more grounding documents as an input; and
receiving, by the format reuse engine, the plurality of updated content elements as an output from the LLM.

9. The method of claim 7, wherein generating the plurality of updated content elements based on the one or more grounding documents comprises:
submitting, to a large language model (LLM) associated with the format reuse engine, the plurality of content elements and the one or more grounding documents as an input;
receiving, by the format reuse engine, a plurality of updated content elements as an output from the LLM, wherein:
the plurality of content elements is generated by the LLM responsive to receiving the input; and
the plurality of content elements is unstructured;
submitting, to the LLM, a request to index the plurality of updated content elements based on the plurality of identifiers and the plurality of content elements; and
receiving, by the format reuse engine, the plurality of updated content elements comprising a plurality of index identifiers, wherein the plurality of index identifiers corresponds to the plurality of identifiers assigned to the plurality of content elements.

10. The method of claim 7, wherein mapping the plurality of updated content elements to the plurality of content elements based on the plurality of identifiers assigned to the plurality of content elements comprises:
determining, by the format reuse engine, that a number of elements in the plurality of updated content elements is less than a number of content elements in the plurality of content elements;
identifying, by the format reuse engine, one or more extra content elements of the plurality of content elements lacking a corresponding updated content element; and
tagging, by the format reuse engine, the one or more extra content elements for removal when replacing the plurality of content elements with the plurality of updated content elements in the updated document.

11. The method of claim 7, wherein mapping the plurality of updated content elements to the plurality of content elements based on the plurality of identifiers assigned to the plurality of content elements comprises:
determining, by the format reuse engine, that a number of elements in the plurality of updated content elements is greater than a number of content elements in the plurality of content elements;
identifying, by the format reuse engine, one or more additional updated content elements from the plurality of updated content elements lacking a corresponding content element of the plurality of content elements; and
assigning, by the format reuse engine, one or more additional identifiers to the one or more additional updated content elements.

12. The method of claim 7, wherein identifying, by the format reuse engine, the one or more grounding documents for updating the content within the input document further comprises:
receiving, by the format reuse engine, a selection of the one or more grounding documents from the client device, wherein each grounding document comprises a plurality of grounding content elements; and
generating, by the format reuse engine, a structured representation of the one or more grounding documents, wherein the structured representation retains a structural relationship of the plurality of grounding content elements as provided in a respective grounding document.

13. The method of claim 7, wherein receiving the request to update content within the input document further comprises:
receiving, from the client device, an indication to update a subset of content within the input document, wherein the subset of content comprises the plurality of content elements.

14. The method of claim 7, wherein the method further comprises:
generating, by the format reuse engine, a template document based on the input document, wherein:
the template document comprises a plurality of placeholder elements and the plurality of formatting elements defining the format, style, and structure of the plurality of placeholder elements; and
a placeholder element of the plurality of placeholder elements corresponds to a respective content element of the plurality of content elements as provided in the input document; and
inserting, by the format reuse engine, the plurality of updated content elements into the plurality of placeholder elements of the template document; and
validating, by the format reuse engine, the plurality of updated content elements as inserted into the plurality of placeholder elements, wherein the updated document is generated based on validation of the plurality of updated content elements as inserted into the plurality of placeholder elements.

15. A computer readable storage media comprising processor-executable instructions configured to cause a processor to:
receive, by a format reuse engine, a request to update content within an input document;
identify, by the format reuse engine, a plurality of content elements and a plurality of formatting elements defining the format, style, and structure of the plurality of content elements within the input document;
determine, by the format reuse engine, a first subset of content elements for updating and a second subset of content elements for preservation, wherein the plurality of content elements comprises the first subset of content elements and the second subset of content elements;
identify, by the format reuse engine, one or more grounding documents;
generate, by the format reuse engine, a plurality of updated content elements based on the first subset of content elements and the one or more grounding documents; and
generate, by the format reuse engine, an updated document by replacing the first subset of content elements with the updated content elements, wherein the updated document preserves the plurality of formatting elements such that the plurality of formatting elements defines the format, style, and structure of the plurality of updated content elements.

16. The computer readable storage media of claim 15, wherein:
the processor-executable instructions to generate, by the format reuse engine, the plurality of updated content elements based on the first subset of content elements and the one or more grounding documents cause the processor to further execute processor-executable instructions stored in the computer readable storage media to:
generate, by the format reuse engine, a structured representation of the first subset of content elements, wherein the structured representation retains a structural relationship of the first subset of content elements as provided in the input document;
submit, to a deep learning model in operable communication with the format reuse engine, the structured representation of the first subset of content elements and the one or more grounding documents as an input; and
receive, by the format reuse engine, the plurality of updated content elements as an output from the deep learning model.

17. The computer readable storage media of claim 15, wherein the processor-executable instructions cause the processor to further execute processor-executable instructions stored in the computer readable storage media to:
assign, by the format reuse engine, a plurality of identifiers to the first subset of content elements, wherein an identifier is assigned to each content element of the first subset of content elements; and
map, by the format reuse engine, the plurality of updated content elements to the first subset of content elements based on the plurality of identifiers assigned to the plurality of content elements.

18. The computer readable storage media of claim 15, wherein the processor-executable instructions to determine, by the format reuse engine, the first subset of content elements for updating and the second subset of content elements for preservation cause the processor to further execute processor-executable instructions stored in the computer readable storage media to:
classify, by the format reuse engine, the plurality of content elements in the input document into:
a substantive content classification comprising content elements that contain substantive content; and
a structural content classification comprising content elements that define document structure;
identify, by the format reuse engine, the first subset of content elements from the substantive content classification; and
identify, by the format reuse engine, the second subset of content elements from the structural content classification.

19. The computer readable storage media of claim 15, wherein the processor-executable instructions to generate, by the format reuse engine, the plurality of updated content elements based on the first subset of content elements and the one or more grounding documents cause the processor to further execute processor-executable instructions stored in the computer readable storage media to:
submit, to a deep learning model in operable communication with the format reuse engine, the first subset of content elements and the one or more grounding documents as an input;
receive, by the format reuse engine, a plurality of updated content elements as an output from the deep learning model, wherein:
the plurality of content elements is generated by the deep learning model responsive to receiving the input; and
a structure of the plurality of content elements is unmatched from a structure of the first subset of content elements;
submit, to the deep learning model, a request to index of the plurality of updated content elements based the first subset of content elements; and
receive, by the format reuse engine, the plurality of updated content elements comprising a plurality of index identifiers, wherein the plurality of index identifiers corresponds to a respective content element of the first subset of content elements.

20. The computer readable storage media of claim 15, wherein the processor-executable instructions cause the processor to further execute processor-executable instructions stored in the computer readable storage media to:
generate, by the format reuse engine, a template document based on the input document, wherein:
the template document comprises a plurality of placeholder elements and the plurality of formatting elements defining the format, style, and structure of the plurality of placeholder elements; and
a placeholder element of the plurality of placeholder elements corresponds to a content element of the first subset of content elements as provided in the input document; and
save, by the format reuse engine, the template document to a template database.
